(19) United States
(12) Patent Application Publication
(10) Pub. No.: US 2016/0219418 A1
(43) Pub. Date: Jul. 28, 2016

(54) HYBRID TERMINAL CAPABLE OF AVOIDING SIGNALS ORIGINATED BY OWN TERMINAL

(71) Applicant: JVC KENWOOD Corporation, Yokohama-shi (JP)

(72) Inventor: Satoru SAKAZUME, Yokohama-shi (JP)

(21) Appl. No.: 14/967,708

(22) Filed: Dec. 14, 2015

(30) Foreign Application Priority Data
Jan. 28, 2015 (JP) 2015-014050

(51) Int. Cl. H04W 4/10; H04W 76/00

(52) U.S. Cl. CPC H04W 4/10; H04W 76/005; H04W 88/06

(57) ABSTRACT

The present invention provides a hybrid terminal capable of resolving a problem arising from receiving and processing a transmission information originated by the own terminal, in a communication system that interconnects a PTT based network and a PoC based network by carrying out protocol conversions at servers of both networks. A hybrid terminal to be used in such a communication system includes a processing module configured to detect whether an ID information contained in a signal received by either the PTT communication function module or the PoC communication function module is an ID information of own terminal or not, and apply a special processing to a received signal that contained the ID information of the own terminal, which is different from an ordinary signal processing applied to any other received signals that contained the ID information other than the ID information of the own terminal.

### CROSS-REFERENCE TO RELATED APPLICATIONS

This application claims benefit of priority to Japanese Patent Application No. 2015-014050 filed on Jan. 28, 2015, the entire contents of which are incorporated by reference herein.

### FIELD OF THE INVENTION

The present invention relates to a hybrid terminal having functions of both a cell phone and a radio terminal.

### BACKGROUND OF THE INVENTION

In Japanese Patent Application Publication No. 2002-536928, a method for realizing a PTT (Push To Talk) function in a cell phone is disclosed. The PTT function is a function for providing a user with a convenience in use as that of a half duplex radio terminal. Namely, the user can originate calls to a plurality of other users and communicate with them by simply pressing a communication button without inputting telephone numbers and the like. The other user will have a speech output of the communication content from a cell phone of that originating user without pressing a response button. The PTT function in the cell phone is also referred to as a PoC (Push-to-Talk over Cellular) function in distinction from the PTT function of the radio terminal.

On the other hand, a hybrid terminal having functions of both a cell phone and a radio terminal is conceivable. In the hybrid terminal, either one of the PoC function in the communication network of the cell phone (hereinafter referred to as LTE/3G network) such as LTE (Long Term Evolution) or 3G (3^{rd} Generation) and the PTT function in the communication network of the radio terminal (hereinafter referred to as LMR (Land Mobile Radio) network) can be selectively used depending on purposes. For example, it suffices to use the PoC function in the case where a high speed communication is desired, or it suffices to use the PTT function in the case where a communication at more remote location is desired.

In the case of contemplating the utilization of the hybrid terminal, it is conceivable to use a communication system that interconnects a PTT based network and a PoC based network by carrying out protocol conversions at servers of both networks. In such a communication system, in the case where the hybrid terminal originates signals with either one of the PTT function and the PoC function, there is a possibility for another one of the PTT function and the PoC function to receive signals originated by the own terminal

### SUMMARY OF THE INVENTION

The present invention has an object of providing a hybrid terminal capable of resolving a problem arising from receiving and processing a transmission information originated by the own terminal, in a communication system that interconnects a PTT based network and a PoC based network.

In order to solve the problem noted above, the present invention provides a hybrid terminal to be used in a communication system that interconnects a PTT based network and a PoC based network by carrying out protocol conversions at servers of both networks, comprising: a PTT communication function module configured to transmit/receive information using a PTT communication function; a PoC communication function module configured to transmit/receive information using a PoC communication function; and a processing module configured to detect whether an ID information contained in a signal received by either the PTT communication function module or the PoC communication function module is an ID information of own terminal or not, and apply a special processing to a received signal that contained the ID information of the own terminal, which is different from an ordinary signal processing applied to any other received signals that contained the ID information other than the ID information of the own terminal.

In this hybrid terminal, the processing module may apply the special processing to prohibit receiving or processing any information subsequent to the ID information of the own terminal

In this hybrid terminal, the processing module may apply the special processing to prohibit a reproduction of the received signal from speakers, when it is detected that the ID information contained in the received signal is the ID information of the own terminal and the received signal includes speech information.

In this hybrid terminal, the processing module may apply the special processing to disconnect a connection to the PTT based network or the PoC based network from which the received signal is received.

In this hybrid terminal, the processing module may add the ID information of the own terminal before a transmission information content of a signal to be originated from the hybrid terminal.

In this hybrid terminal, the processing module may switch a state of the hybrid terminal from a receiving waiting state at one of the PTT communication function module and the PoC communication function module to a receiving waiting state at another one of the PTT communication function module and the PoC communication function module, in response to a command from a server of one of the PTT based network and the PoC based network so as to be able to receive an emergency information occurring in said one of the PTT based network and the PoC based network.

According to the present invention, it is possible to provide a hybrid terminal capable of resolving a problem arising from receiving and processing a transmission information originated by the own terminal, in a communication system that interconnects a PTT based network and a PoC based network.

### BRIEF DESCRIPTION OF THE DRAWINGS

FIG. 1 is a block diagram showing an exemplary configuration of a hybrid terminal according to one embodiment of the present invention.

FIG. 2 is a network diagram showing a configuration of a communication system containing the hybrid terminal according to one embodiment of the present invention.

FIG. 3 is a network diagram showing another configuration of a communication system containing the hybrid terminal according to one embodiment of the present invention.

FIG. 4 is a network diagram showing another configuration of a communication system containing the hybrid terminal according to one embodiment of the present invention.

### DETAILED DESCRIPTION OF THE INVENTION

In the following, one embodiment of the hybrid terminal according to the present invention will be described in detail with references to the drawings.

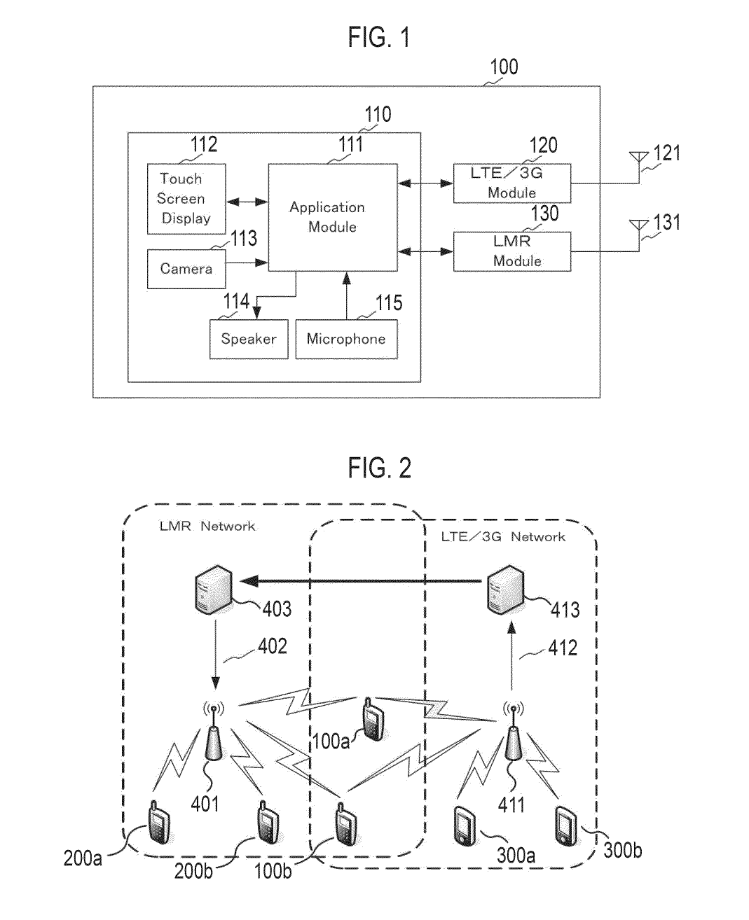

FIG. 1 is a block diagram showing an exemplary configuration of a hybrid terminal according to one embodiment of the present invention.

The hybrid terminal 100 includes an application processing unit 110, an LTE/3G module 120, and an LMR module 130. The application processing unit 110 includes an application module 111 for carrying out a signal processing and a control of the hybrid terminal as a whole, a touch screen display 112 that functions both as an operation input unit and a display unit, a camera 113, a speaker 114, and a microphone 115. The hybrid terminal 100 may also include a unit for executing a GPS function or a unit for executing a near distance wireless function such as Bluetooth, although it is not shown in the figure.

The application processing unit 110 executes various types of applications. For example, in the case of transmitting/receiving speech signals, the application processing unit 110 encodes the speech signals inputted from the microphone 115 and sends them to the LTE/3G module 120 or the LMR module 130. Also, the application processing unit 110 decodes signals inputted from the LTE/3G module 120 or the LMR module 130 and outputs them from the speaker 114.

The LTE/3G module 120 is connected to an LTE/3G network via an antenna 121, and carries out a transmission of signals received from the application module 111 while receiving and sending signals received from the LTE/3G network to the application module 111. The LMR module 130 is connected to an LMR network via an antenna 131, and carries out a transmission of signals received from the application module 111 while receiving and sending signals received from the LMR network to the application module 111.

In the following, the operation at a time of transmitting and receiving speech signals will be described. In this case, the user selects whether to transmit signals with the PoC function or with PTT function, at the touch screen display 112. In the case where the PoC function is selected, the application module 111 transmits the speech signals inputted at the microphone 115 via the LTE/3G module 120. In the case where the PTT function is selected, the application module 111 transmits the speech signals inputted at the microphone 115 via the LMR module 130.

In the case of transmitting signals with the PoC function or the PTT function, it is possible to receive signals by using the other module that is not used for transmission. Namely, in the case of transmitting signals using the PoC function, it is possible to receive speech signals from the PTT based network by using the LMR module 130. Similarly, in the case of transmitting signals using the PTT function, it is possible to receive speech signals from the PoC based network by using the LTE/3G module 120.

In the case of not transmitting any signals, both of the LTE/3G module 120 and the LMR module 130 may be set in a receiving waiting state, or either one of them may be selectively set in a receiving waiting state.

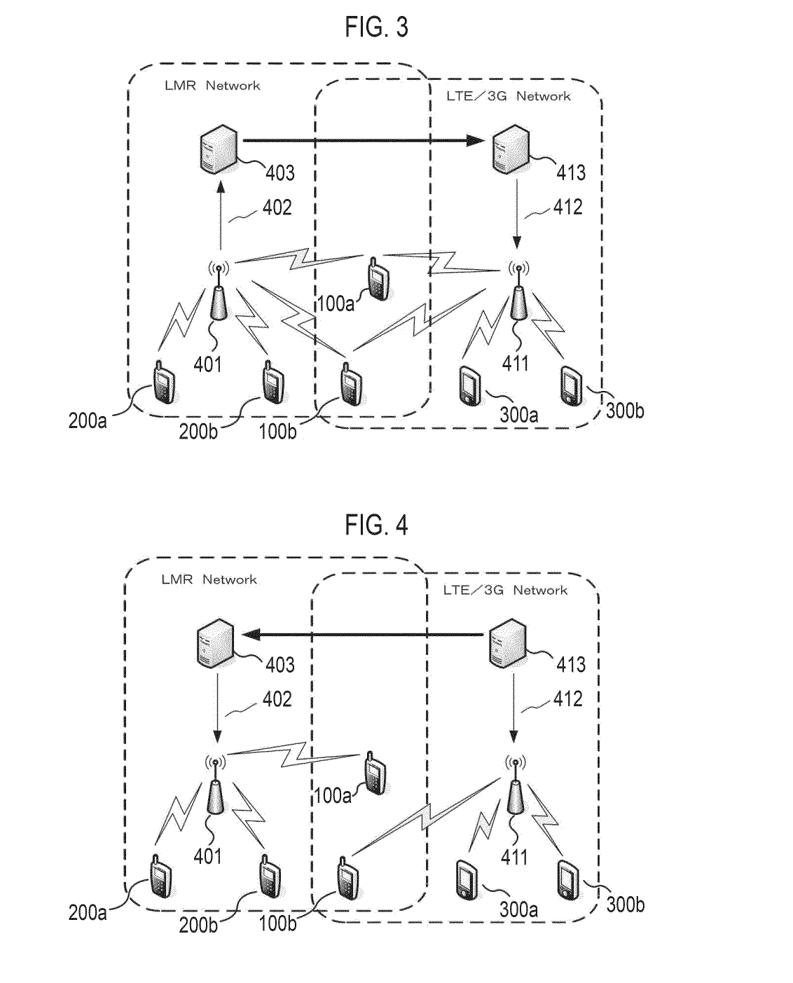

Now, a configuration of a communication system containing the hybrid terminal 100 (100a, 100b) of the present invention will be described with references further to FIG. 2 and FIG. 3.

Radio terminals 200a, 200b are connected to an LMR wireless base station 401. The radio terminals 200a, 200b transmit and receive information with respect to a server on an LMR side (referred hereinafter as LMR server) 403 via an LMR network 402 (which may be the Internet).

Cell phones 300a, 300b are connected to an LTE/3G wireless base station 411. The cell phones 300a, 300b transmit and receive information with respect to a server on an LTE/3G side (referred hereinafter as LTE/3G server) 413 via an LTE/3G network 412 (which may be the Internet).

Hybrid terminals 100a, 100b are connected to the LMR wireless base station 401 and the LTE/3G wireless base station 411. The hybrid terminals 100a, 100b transmit and receive information with respect to the LMR server 403 via the LMR network 402, and also transmit and receive information with respect to the LTE/3G server 413 via the LTE/3G network 412.

In the case of carrying out the transmission, the hybrid terminal 100a or 100b adds an information for identifying own terminal (referred hereinafter as terminal ID information) to a transmission information content. Here, this terminal ID information may be configured to be added or transmitted before the transmission information content, whenever the transmission operation is carried out. In this way, it becomes possible to check which terminal's information it is before the transmission information content arrives at a time of receiving.

Between the LMR server 403 and the LTE/3G server 413, a prescribed conversion is carried out with respect to information to be exchanged, such that an exchange of information between different networks becomes possible. Here, as far as a portion related to the terminal ID information is concerned, a conversion of information may be made in a format that can be recognized at least by the hybrid terminal. For example, at the LTE/3G server 413, the terminal ID information that is added before the information transmitted by the hybrid terminal 100a or 100b may be converted into a format that can be interpreted by the LMR server 403, without applying any conversion to the transmission information content.

### <First Exemplary Case>

In FIG. 2, the operation in the case where the hybrid terminal 100a carried out the transmission of information by the PoC operation will be described. In carrying out the transmission of information by the PoC operation, the hybrid terminal 100a adds the terminal ID information before the information to be transmitted. The terminal ID information and the transmission information content transmitted by the hybrid terminal 100a are supplied to the LTE/3G server 413 via the LTE/3G wireless base station 411 and the LTE/3G network 412.

The LTE/3G server 413 converts the acquired information from a PoC based format to a PTT based format, and supplies the converted information to the LMR server 403. Here, at a time of converting information into the PTT based format, a transmission format alone may be converted without applying any conversion to the content of the terminal ID information that is added before the transmission information content. The LMR server 403 acquires this information that has been converted such that it can be interpreted by the PTT based network, and multicasts this information via the LMR network 402 and the LMR wireless base station 401.

The information that is transmitted from the LMR wireless base station 401 in this way is then received by the radio terminals 200a, 200b and the hybrid terminal 100b that are connected to the LMR network 402.

Here, even at the hybrid terminal 100a that has transmitted the information to the PoC based network, it is possible to receive the information that has been transmitted from the LMR wireless base station 401. However, in the case where the transmitted information is the speech information taken from the microphone 115 of the hybrid terminal 100a, if the received information were to be reproduced from the speaker 114 of the hybrid terminal 100a, there would be a possibility of giving adverse effects such as howling.

For this reason, the hybrid terminal 100a that has transmitted the information detects the terminal ID information added before the transmission information content, and compares it to see if it is the same terminal ID information as the terminal ID information of the own terminal or not. When it is the same terminal ID information, the hybrid terminal 100a does not receive any subsequent information, or does not carry out a signal processing after receiving. Here, it is assumed that the hybrid terminal 100a receives the information but prohibits the reproduction from the speaker 114 in the case where the received information is the speech information.

It is also possible to contemplate the case of disconnecting the connection on the LMR side here. In that case, however, if an emergency communication occurs on the LMR side during the transmission, it would be impossible to receive this emergency communication.

In the above description, the hybrid terminal 100a added the terminal ID information before the information to be transmitted, but it may be possible to make the LTE/3G server 413 to add the terminal ID information if the LTE/3G server 413 is capable of individually identifying each hybrid terminal 100a or 100b, rather than transmitting the terminal ID information from each hybrid terminal 100a or 100b. Note however that the terminal ID information to be added by the LTE/3G server 413 should be the terminal ID information that can be recognized by the relevant hybrid terminal itself.

### <Second Exemplary Case>

FIG. 3 shows the case where the hybrid terminal 100a carried out the transmission of information by the PTT operation, in the same system configuration as in FIG. 2.

In carrying out the transmission of information by the PTT operation, the hybrid terminal 100a adds the terminal ID information before the information to be transmitted. The terminal ID information and the transmission information content transmitted by the hybrid terminal 100a are supplied to the LMR server 403 via the LMR wireless base station 401 and the LMR network 402.

The LMR server 403 converts the acquired information from a PTT based format to a PoC based format, and supplies the converted information to the LTE/3G server 413. Here, at a time of converting information into the PoC based format, a transmission format alone may be converted without applying any conversion to the content of the terminal ID information that is added before the transmission information content.

The LTE/3G server 413 acquires this information that has been converted such that it can be interpreted by the PoC based network, and multicasts this information via the LTE/3G network 412 and the LTE/3G wireless base station 411.

The information that is transmitted from the LTE/3G wireless base station 411 in this way is then received by the cell phones 300a, 300b and the hybrid terminal 100b that are connected to the LTE/3G network 412.

Here, even at the hybrid terminal 100a that has transmitted the information to the PTT based network, it is possible to receive the information that has been transmitted from the LTE/3G wireless base station 411. However, in the case where the transmitted information is the speech information taken from the microphone 115 of the hybrid terminal 100a, if the received information were to be reproduced from the speaker 114 of the hybrid terminal 100a, there would be a possibility of giving adverse effects such as howling.

For this reason, the hybrid terminal 100a that has transmitted the information detects the terminal ID information added before the transmission information content, and compares it to see if it is the same terminal ID information as the terminal ID information of the own terminal or not. When it is the same terminal ID information, the hybrid terminal 100a does not receive any subsequent information, or does not carry out a signal processing after receiving. Here, it is assumed that the hybrid terminal 100a receives the information but prohibits the reproduction from the speaker 114 in the case where the received information is the speech information.

It is also possible to contemplate the case of disconnecting the connection on the LTE/3G side here. In that case, however, if an emergency communication occurs on the LTE/3G side during the transmission, it would be impossible to receive this emergency communication.

In the above description, the hybrid terminal 100a added the terminal ID information before the information to be transmitted, but it may be possible to make the LMR server 403 to add the terminal ID information if the LMR server 403 is capable of individually identifying each hybrid terminal 100a or 100b, rather than transmitting the terminal ID information from each hybrid terminal 100a or 100b. Note however that the terminal ID information to be added by the LMR server 403 should be the terminal ID information that can be recognized by the relevant hybrid terminal itself.

### <Third Exemplary Case>

The third exemplary case contemplates a situation in which the hybrid terminal 100a, 100b is originally in the receiving waiting state at either the LTE/3G module 120 or the LMR module 130, in the similar system configuration as in the first exemplary case. In FIG. 4, the hybrid terminal 100a is in the receiving waiting state at the LMR module 130, and the hybrid terminal 100b is in the receiving waiting state at the LTE/3G module 120.

In this situation, when the emergency information is transmitted within the LTE/3G network 412, the hybrid terminal 100b can receive the emergency information directly from the LTE/3G wireless base station 411, but the hybrid terminal 100a cannot receive the emergency information directly from the LTE/3G wireless base station 411.

As described in the first exemplary case, the hybrid terminal 100a can be made to be able to receive information from the LMR wireless base station 401, if the LTE/3G server 413 is made to convert the acquired information from the PoC based format to the PTT based format and supply the converted information to the LMR server 403. However, in the case where the emergency information is transmitted as data of large capacity containing image data, for example, the LMR network 402 may take a long time for transmission, or may have a possibility of being unable to transmit information completely.

In order to avoid such a trouble, when the emergency information is received, the LTE/3G server 413 commands the LMR server 403 to detect one hybrid terminal that can be connected to the LTE/3G wireless base station 411 among the hybrid terminals that are currently connected to the LMR wireless base station 401 but not connected to the LTE/3G wireless base station 411, and makes that one hybrid terminal to connect to the LTE/3G wireless base station 411. If that one hybrid terminal is the hybrid terminal 100a, the hybrid terminal 100a switches from the receiving waiting state at the LMR module 130 to the receiving waiting state at the LTE/3G 120 according to the command received via the LMR wireless base station 401, such that the hybrid terminal 100a can receive the emergency information directly from the LTE/3G wireless base station 411.

The third exemplary case has been an exemplary case where the hybrid terminal 100a is originally in the receiving waiting state at the LMR module 130, and when the emergency information is transmitted within the LTE/3G network 412, the hybrid terminal 100a is made to switch to the receiving waiting state at the LTE/3G module 120. Alternatively, it may be possible to make the configuration such that the hybrid terminal 100a is originally in the receiving waiting state at the LTE/3G module 120, and when the emergency information is transmitted within the LMR network 402, the hybrid terminal 100a is made to switch to the receiving waiting state at the LMR module 130.

Although the present invention has been fully described in connection with the preferred embodiment thereof with reference to the accompanying drawings, it is apparent to those skilled in the art that any changes and modifications are to be understood as included within the scope of the present invention as defined by the appended claims.

1. A hybrid terminal to be used in a communication system that interconnects a PTT (Push To Talk) based network and a PoC (Push-to-Talk over Cellular) based network by carrying out protocol conversions at servers of both networks, comprising:
a PTT communication function module configured to transmit/receive information using a PTT communication function;
a PoC communication function module configured to transmit/receive information using a PoC communication function; and
a processing module configured to detect whether an ID information contained in a signal received by either the PTT communication function module or the PoC communication function module is an ID information of own terminal or not, and apply a special processing to a received signal that contained the ID information of the own terminal, which is different from an ordinary signal processing applied to any other received signals that contained the ID information other than the ID information of the own terminal.

2. The hybrid terminal of claim 1, wherein the processing module applies the special processing to prohibit receiving or processing any information subsequent to the ID information of the own terminal.

3. The hybrid terminal of claim 1, wherein the processing module applies the special processing to prohibit a reproduction of the received signal from speakers, when it is detected that the ID information contained in the received signal is the ID information of the own terminal and the received signal includes speech information.

4. The hybrid terminal of claim 1, wherein the processing module applies the special processing to disconnect a connection to the PTT based network or the PoC based network from which the received signal is received.

5. The hybrid terminal of claim 1, wherein the processing module adds the ID information of the own terminal before a transmission information content of a signal to be originated from the hybrid terminal.

6. The hybrid terminal of claim 1, wherein the processing module switches a state of the hybrid terminal from a receiving waiting state at one of the PTT communication function module and the PoC communication function module to a receiving waiting state at another one of the PTT communication function module and the PoC communication function module, in response to a command from a server of one of the PTT based network and the PoC based network so as to be able to receive an emergency information occurring in said one of the PTT based network and the PoC based network.
